(19) United States
(12) Patent Application Publication
(10) Pub. No.: US 2008/0271935 A1
(43) Pub. Date: Nov. 6, 2008

(54) MULTIPLE WINDING ELECTRIC MACHINE

(76) Inventor: Erkan Mese, Rochester Hills, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/743,990

(22) Filed: May 3, 2007

(51) Int. Cl. B60K 6/26; H02K 47/14; H02P 11/04

(52) U.S. Cl. 180/53.5; 310/198; 322/16; 903/906

(57) ABSTRACT

An exemplary embodiment provides an electrical machine apparatus that includes a rotor coupled to an armature and a stator surrounding the rotor. The stator has a series of coils; the series of coils configured into a first group of coils and a second group of coils, the first group of coils electrically and magnetically isolated from the second group of coils. The electric machine is capable of simultaneously acting as an electric motor and generating electricity as an alternator.

### TECHNICAL FIELD

The embodiments described herein generally relate to electric machines including motors and generators, and more particularly relates to an electric machine that can simultaneously function as a motor and as a generator/alternator, or as either one or the other.

### BACKGROUND

In principle, a typical electric motor includes a central rotor surrounded by a stator and an armature coupled to the rotor. The stator includes wires or coils through which an electrical current flows to produce a magnetic field. The magnetic field interacts with an armature that in turn applies a torque to the rotor thereby causing the rotor to rotate. An example of a simple electric motor 10 is shown in schematic form in FIG. 1. The motor 10 includes a stator 12 made up of a pair of permanent magnets 14, 16 in this example. Stators may also include a cylindrical ring containing coils that generate a magnetic field, when the coils are energized, for example. In FIG. 1, an armature 20 has a pair of armature coils 22. The armature 20 is coupled to a rotor 30. When the coils 22 are energized, the resulting electromagnetic field (vectors of which are depicted by broken arrows 40) interacts with the magnetic field of the permanent magnets 14, 16 causing the armature 20 and coupled rotor 30 to rotate. Rotation of rotor 30 imparts driving force to coupled levers 35.

Electric motors are relatively efficient in converting electrical energy into mechanical energy and as a result there is an increasing interest in such motors in a variety of applications, including in the automotive field. For example, in the field of “hybrid” powered vehicles that use a combination of an internal combustion engine and one or more electric motors to provide motive power. Generally, electrical energy to power the electric motors is stored in an energy pack (“battery”) that includes a plurality of rechargeable energy storage cells. Electrical electric motors find application in other areas in hybrid vehicles besides providing additional or supplements motive power. For example, electric motors may provide power to a range of vehicular accessories that might otherwise be powered via hydraulic or other systems that are often driven via systems of belts and pulleys from torque supplied by an internal combustion engine.

In addition to electric motors, automotive vehicles generally also include a generator. In conventional internal combustion engine-powered vehicles, the main purpose of the alternator was to re-charge the battery of the vehicle to replenish battery charge used in electrical systems, such as head lights, windshield wiper motors, and starter motors. Increasingly, mid-to-upscale conventional (non hybrid) vehicles require larger alternators because of electrical consumption by accessories of all kinds. In the case of hybrid vehicles, in particular, the motive electric motor(s) and accessory-drive electric motor(s) consume much more electrical energy than in conventional internal combustion vehicles. Accordingly, greater alternator capacity is necessary to recharge the battery to replenish energy consumed from the battery. Greater capacity may necessitate either an increase in alternator size or the use of multiple alternators. This need for increased alternator capacity further exacerbates both the packaging issues and the vehicular mass increase issues presented by the use of additional electric motors and a larger battery pack in hybrid vehicles. In mid-to-upscale non-hybrid vehicles there is also a growing need for a larger battery and larger alternator or multiple alternators. The increased equipment volume resulting from multiple and/or larger motors and alternators may be expected reduce occupant-usable space in the vehicle (or require a larger vehicle which adds mass). The increased mass from multiple and/or larger motors and alternators may be expected to reduce fuel efficiency. All other factors being equal, fuel efficiency declines as vehicular mass increases. Other performance criteria that are often important to consumers also suffer as vehicular mass increases, e.g. acceleration, handling on the road, and the like. Thus, both occupant utility and performance penalties may result.

In addition, depending upon the configuration of the hybrid vehicle, it may be necessary or desirable under certain conditions to consume electrical energy from a battery while simultaneously recharging another battery via an alternator. On other occasions, simultaneous electrical energy usage from a battery and recharging another battery may not be necessary.

Accordingly, it is desirable to develop electric machines that are compact and light weight especially for applications where there are packaging and mass limitations. In addition, it is desirable that these electric machines be capable of simultaneously providing torque to mechanically drive systems and also recharging a battery or other storage device. Further, it is desirable that the electric machines be manufactured with ease, without requiring major retrofitting or replacement of manufacturing tools. Other desirable features and characteristics of the multiple winding electric machines will become apparent from the subsequent detailed description and the appended claims, taken in conjunction with the accompanying drawings and the foregoing technical field and background.

### BRIEF SUMMARY

An exemplary embodiment provides an electrical machine apparatus that includes a rotor coupled to an armature and a stator surrounding the rotor. The stator has a series of coils. The series of coils is configured into a first group of coils and a second group of coils. The first group of coils is electrically and magnetically isolated from the second group of coils. The electric machine is capable of simultaneously acting as an electric motor and generating electricity as an alternator.

In another exemplary embodiment, an electric machine is provided that simultaneously provides mechanical torque and generates electrical power. The electric machine has a rotor coupled to an armature and a stator surrounding the rotor. The stator includes a series of coils. The series of coils is configured into a first group of coils and a second group of coils. The first group of coils is electrically and magnetically isolated from the second group of coils. The first group of coils includes first pairs of coils, and the second group of coils includes second pairs of coils. Thus, when the rotor rotates, the second group of coils is electrically energized.

In a further exemplary embodiment, there is provided an electric machine circuit. The electric machine circuit includes: an electric machine providing motive power and simultaneously generating electrical power, means for configuring input electrical energy to energize the second group of coils and thereby rotate the rotor of the electric machine, and means for configuring output electrical energy from the first group of coils so that configured output electrical energy is suitable for use in another operation. The electric machine includes a rotor coupled to an armature and a stator surrounding the rotor. The stator includes a series of coils. The series of coils is configured into a first group of coils and a second group of coils. The first group of coils is electrically and magnetically isolated from the second group of coils. The first group of coils includes first pairs of coils and the second group of coils includes second pairs of coils.

### BRIEF DESCRIPTION OF THE DRAWINGS

Various embodiments will hereinafter be described in conjunction with the following drawing figures, wherein like numerals denote like elements, and

FIG. 1 is a schematic showing details of a prior art electric motor; and

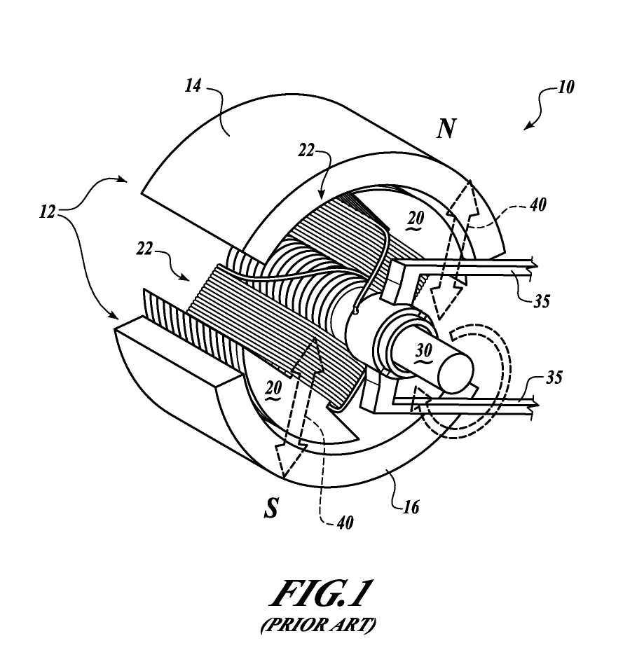

FIG. 2 is a schematic illustration of an exemplary embodiment of an electric machine and an example of associated circuits.

### DETAILED DESCRIPTION

The following detailed description is merely exemplary in nature and is not intended to limit the described embodiments or the application and uses of the described embodiments. Furthermore, there is no intention to be bound by any expressed or implied theory presented in the preceding technical field, background, brief summary or the following detailed description.

An exemplary embodiment provides a “dual coil set” electric machine that can simultaneously operate as motor and alternator, or operate as either one or the other. The electric machine includes a stator, a rotor and electrically conductive coils as major components. Existing manufacturing tools may be configured to fabricate the electric machine. The coils differ from those of conventional electric motors in that the coils are provided as “dual coil sets.” “Dual coil sets” or “dual coil groups” as used herein means that the electric motor includes two electrically and magnetically isolated sets or groups of coils. Under certain conditions, one set or group of coils could be used in a motor function to cause the rotor to rotate while the other set or group of coils may be simultaneously act as an alternator generating current as the rotor rotates. Thus, under in certain applications, both sets of coils may operate simultaneously to provide a single electric machine that is simultaneously an electric motor and an alternator.

As explained above, each of the dual coil sets are electrically isolated from and independent from each other. This allows motor only, alternator only and simultaneous motor and alternator operations. In addition, especially in embodiments where both coil sets are in a single stator, the two coil sets are also magnetically isolated from each other. Magnetic isolation (or decoupling) may achieved by using a “concentrated coil” technique. In this concentrated coil technique, each coil is wound around only one stator tooth and each coil has an independent flux path. This ensures magnetic decoupling between the two coil sets.

In exemplary embodiments the dual coil sets may be controlled independently. For example, motor torque and/or speed can be controlled through controlling the current in the motor coil without effecting the operation of the alternator coil. This simultaneous dual-mode of operation feature is useful in a variety of applications. For example, the system would find application in hybrid vehicles in an electric accessory drive system (EADS). One coil set may be used as a motor coil set while the other one may be used as an alternator coil set. In EADS that are configured such that vehicle accessories (air conditioner, for example) are driven by a motor when the engine is shut down, an electric motor ensures continuous operation of accessories. To save space and reduce total mass, an exemplary embodiment of the dual coil electric machine adds a second coil set to the EADS electric motor housing. The second coil set is configured to be used as an alternator to generate electrical energy to recharge a battery, for example, a 12 Volts DC battery, or for another purpose.

Conventional vehicles use a Lundell-type alternator to generate 12 Volts DC. Hybrid vehicles, on the other hand, may be configured to use an Auxiliary Power Module (APM) to step down voltage so as to obtain 12 Volts out of a high voltage storage battery (for example, a “high voltage” may be in the range from about 40 to about 300 Volts, or about 288 Volts). An APM is basically a DC/DC converter which is used to supply vehicle loads that have a nominal voltage level of 12 V. The APM has DC input power from a higher voltage battery and its output supplies 12 V DC power to the vehicle loads. Unlike a conventional Lundell-type alternator, which cannot be used in a “conventional hybrid vehicle” because when the engine stops the alternator also stops and does not generate power, an APM can continue to supply power without interruption. A “conventional hybrid vehicle” may be regarded as hybrid vehicle that is not equipped with EADS. Examples of embodiments of the invention overcome not only the low efficiency and power limitation issues of Lundell-type machines but also offer cost effective replacement for APM in AHS2 hybrid architecture and other similar architecture. AHS2 is General Motor's 2-Mode Advanced Hybrid System which uses two electric motors and two planetary gear sets and clutches. The exemplary embodiments may be useful in connection with other similar systems of other manufacturers.

In other examples of embodiments, both coil sets may be used as alternator coil sets when the machine shaft is supplied with mechanical power. This particular embodiment is especially suitable for applications where two different voltages must be generated and eliminates the need for two alternators. Thus, it provides a cost-effective solution for supplying two different voltage systems, for example, a 42 volt system and a 12 volt system, or a 288 Volt system and a 12 Volt system, on the same vehicle.

Exemplary embodiments may provide a full range of independent controllability of the two coil groups without affecting each other's operation. Further, some exemplary embodiments offer packaging and cost benefits. Appropriately configured stator, rotor and coils offer significant efficiency benefits as compared to conventional alternators. Those embodiments that use concentrated windings, offer potentially higher efficiency and ease of manufacture as compared to distributed winding. Exemplary embodiments that have a single stator with dual coil groups offer more compact electric machines with greater ease of manufacture than axially-cascaded dual stator electric machines.

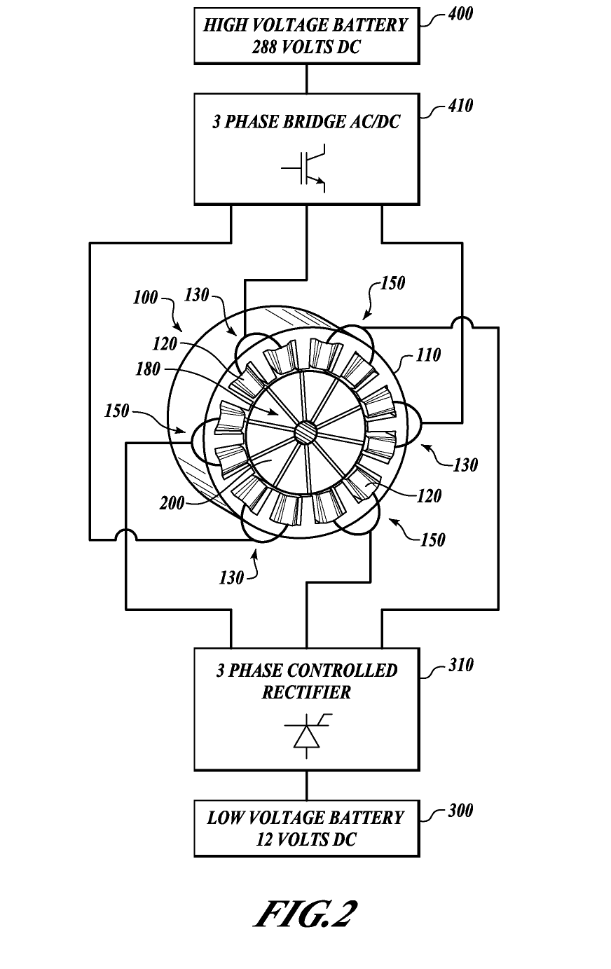

FIG. 2 illustrates an example of a single stator dual coil electric machine. In this example, electric machine 100 includes a central rotor 200 and a surrounding stator 110. The stator includes a series of coils 120 (only two indicated by numeral to avoid clutter in illustration) arrayed in a circle. Each coil 120 is wound upon a single tooth (not shown), and the coils 120 are wound by the concentrated coil technique and spaced apart such that each coil 120 is magnetically isolated from adjacent coils 120. Further, in the illustrated example the coils 120 are electrically coupled together in alternating coil groups 130, 150. In this case, the groups are pairs of coils 130, 150. The coil pairs 130 are isolated electrically from the coil pairs 150. Thus, the electric machine has a “dual coil set” in that it has two sets of coils or coils that are electrically isolated from each other.

Of course, the technology is not restricted to alternating pairs 130, 150 of coils 120. Indeed, the coils 120 may be grouped into three-coil or four-coil or other groups of coils and need not necessarily alternate symmetrically, as shown in this example, but can be arranged in a different pattern in the stator 110. Depending upon desired use and needs, a first coil group may have more coils than a second coil group. Further, the total number of coils of the first coil groups may be greater than the total number of coils in the second coil groups. The number of coils per group and the number of groups in winding set are determined based on the power and voltage levels of the applications. As a general principle, the selection of the number of coils or groups should not have any significant effect on examples of embodiments of the multiple winding electric motors. For example, electric machine design may be determined through a typical electric machine design process by setting parameters to ensure that the coils are magnetically isolated. The limitations to physical size (packaging) and the requirement of coil magnetic isolation may dictate the number of coils and groups.

Referring to FIG. 2, coil pairs 150 together act as an alternator providing energy to re-charge low voltage battery 300, in this case a 12 volt DC rechargeable battery. As may be desired or necessary, the current generated in coil pairs 150, when rotor 180 rotates, passes through a 3-phase controlled rectifier 310, or similar device, such as AC/DC inverter or rectifier and the like, to appropriately configure the voltage for charging battery 300. Rotor 180 is coupled to an armature, not shown, as is necessary to rotate the rotor 180.

Coil pairs 130, on the other hand, receive electrical energy from high voltage battery 400; in the illustrated example this may be a 288 volt battery used in some General Motors (General Motors and GM are trademarks of General Motors, based in Detroit Mich., hereinafter “GM”) hybrid vehicle applications, although other high voltage sources are also useful. Electricity is delivered through a 3-phase ac/dc inverter 410 or device performing a similar function. This energy energizes coil pairs 130 and causes rotor 180 to rotate; i.e. coil pairs 130 drive the electric motor feature of the electric machine 100. The mechanical torque energy provided by the motor may be used to drive any of a variety of accessories in automotive applications, or may be used to provide sole or supplemental motive force.

The example of FIG. 2, with coil pairs 130 and coil pairs 150 electrically and magnetically isolated from each other allow simultaneous operation of the electric machine as a motor using coil pairs 130 and as a generator or alternator using coil pairs 150, as the rotor 180 rotates. On the other hand, if only the alternator function is required, the electric motor may be uncoupled from mechanical load and the battery 400 may be used to turn the rotor 180 to allow coil pairs 150 to perform the alternator function of charging battery 300. If only the electric motor function is needed, battery 400 may power the coil pairs 130 to drive the motor. The coil pairs 150 may be open circuited so that battery 300 does not receive re-charge energy.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

What is claimed is:

1. An electric machine, comprising:
a rotor coupled to an armature; and
a stator surrounding the rotor, the stator comprising a series of coils; the series of coils configured into a first group of coils and a second group of coils, the first group of coils electrically and magnetically isolated from the second group of coils.

2. The electric machine of claim 1, wherein the first group of coils comprises first pairs of coils, and the second group of coils comprises second pairs of coils.

3. The electric machine of claim 2, wherein the first pairs of coils alternates with the second pairs of coils.

4. The electric machine of claim 2, wherein the rotor of the electric machine rotates when the first group of coils is energized from a remote power source.

5. The electric machine of claim 2, wherein the second group of coils is energized when the rotor rotates so that the second group of coils functions as a generator.

6. The electric machine of claim 2, wherein the rotor of the electric machine rotates when the first group of coils is energized from a remote power source; and wherein the second group of coils is energized when the rotor rotates so that the second group of coils functions as a generator while the rotating rotor provides mechanical torque.

7. The electric machine of claim 6, wherein the electric machine is configured for use in a hybrid internal combustion-electric vehicle, and wherein the first group of coils is adapted to receive a high voltage electrical supply and the second group of coils is adapted to generate a lower volt electrical supply.

8. The electric machine of claim 2, wherein the first group of coils is configured to generate electricity at a first voltage, and the second group of coils is configured to generate electricity at a second voltage different from the first voltage.

9. The electric machine of claim 7, wherein the rotor has sufficient torque to drive vehicular accessories.

10. An electric machine providing mechanical torque and simultaneously generating electrical power, the electric machine comprising:
a rotor coupled to an armature; and
a stator surrounding the rotor, the stator comprising a series of coils; the series of coils configured into a first group of coils and a second group of coils, the first group of coils electrically and magnetically isolated from the second group of coils, the first group of coils comprising first pairs of coils, and the second group of coils comprising second pairs of coils;
whereby, when the rotor rotates to provide mechanical torque, the electrical voltage is induced across the second group of coils.

11. The electric machine of claim 10, wherein the series of coils comprises in alternating sequence a first pair of coils and a second pair of coils.

12. The electric machine of claim 10, wherein the rotor of the electric machine rotates when the first group of coils is energized from a remote power source.

13. The electric machine of claim 10, wherein the electric machine is configured for use in a hybrid internal combustion-electric vehicle, and wherein the first group of coils is adapted to receive a high voltage electrical supply and the second group of coils is adapted to generate a lower volt electrical supply.

14. The electric machine of claim 10, wherein the stator comprises a single stator and the series of coils are configured in a circular array in the single stator.

15. An electric machine circuit comprising:
an electric machine providing motive power and simultaneously generating electrical power, the electric machine comprising:
a rotor coupled to an armature; and
a stator surrounding the rotor, the stator comprising a series of coils; the series of coils configured into a first group of coils and a second group of coils, the first group of coils electrically and magnetically isolated from the second group of coils, the first group of coils comprising first pairs of coils, and the second group of coils comprising second pairs of coils; and
a means for configuring input electrical energy to energize the second group of coils and thereby rotate the rotor; and
a means for configuring output electrical energy from the first group of coils so that configured output electrical energy is suitable for use in another operation.

16. The electric machine circuit of claim 15, wherein the electric machine is configured for use in a hybrid internal combustion-electric vehicle, and wherein the first group of coils is adapted to receive a high voltage electrical supply and the second group of coils is adapted to generate a lower volt electrical supply.

17. The electric machine circuit of claim 16, wherein the means for configuring input electrical energy comprises a 3-phase AC/DC inverter.

18. The electric machine circuit of claim 16, wherein the means for configuring output electrical energy comprises any one of a 3-phase controlled rectifier or an AC/DC inverter.

19. The electric machine circuit of claim 15, wherein the series of coils comprises in alternating sequence a first pair of coils and a second pair of coils.

20. The electric machine circuit of claim 15, wherein the stator comprises a single stator and the series of coils are configured in a circular array in the single stator.
